(19) United States
(12) Patent Application Publication
(10) Pub. No.: US 2016/0259705 A1
(43) Pub. Date: Sep. 8, 2016

(54) BREAKPOINT PREDICTION

(71) Applicant: International Business Machines Corporation, Armonk, NY (US)

(72) Inventors: Eric L. Barsness, Pine Island, MN (US); Michael J. Branson, Rochester, MN (US); Bradford L. Cobb, Katy, TX (US); John M. Santosuosso, Rochester, MN (US)

(21) Appl. No.: 14/638,527

(22) Filed: Mar. 4, 2015

(51) Int. Cl. G06F 11/34

(52) U.S. Cl. CPC G06F 11/3466; G06F 11/3447

(57) ABSTRACT

A method is provided for breakpoint prediction. The method can include accessing a breakpoint within a set of programming instructions hosted by a compute node in a distributed computing platform. The method can also include determining data that triggers the breakpoint. The method can also include creating a model for generating a first time-based prediction of when the breakpoint is triggered. The method can also include monitoring for the triggering data. The method can also include generating, in response to detecting the triggering data, the first time-based prediction and likelihood of the first time-based prediction based on the model. The method can also include displaying the first time-based prediction and likelihood of the first time-based prediction.

### BACKGROUND

This disclosure generally relates to monitoring program execution, and in particular, to monitoring program execution using breakpoints.

Database systems are typically configured to separate the process of storing data from accessing, manipulating, or using data stored in a database. More specifically, database systems use a model in which data is first stored and indexed in a memory before subsequent querying and analysis. In general, database systems may not be well suited for performing real-time processing and analyzing streaming data. In particular, database systems may be unable to store, index, and analyze large amounts of streaming data efficiently or in real time.

### SUMMARY

Embodiments of the disclosure provide a method, system, and computer program product for predicting breakpoints.

One embodiment is directed toward a method of breakpoint prediction. The method can include accessing a breakpoint within a set of programming instructions hosted by a compute node in a distributed computing platform. The method can also include determining data that triggers the breakpoint. The method can also include creating a model for generating a first time-based prediction of when the breakpoint is triggered. The method can also include monitoring for the triggering data. The method can also include generating, in response to detecting the triggering data, the first time-based prediction and likelihood of the first time-based prediction based on the model. The method can also include displaying the first time-based prediction and likelihood of the first time-based prediction.

Another embodiment is directed toward a system of breakpoint prediction. The system can include one or more compute nodes, a memory, and a computer processor communicatively coupled to the memory. The system can include a breakpoint analyzer communicatively coupled to the memory and the computer processor. The breakpoint analyzer can be configured to access a breakpoint within a set of programming instructions hosted by a compute note in the distributed computing platform. The breakpoint analyzer can be configured to determine data that triggers the breakpoint. The breakpoint analyzer can be configured to create a model for generating a first time-based prediction of when the breakpoint is triggered. The breakpoint analyzer can be configured to monitor for the triggering data. The breakpoint analyzer can be configured to generate, in response to detecting the triggering data, the first time-based prediction and likelihood of the first time-based prediction based on the model. The breakpoint analyzer can be configured to display the first time-based prediction and likelihood of the first time-based prediction.

Another embodiment is directed toward a computer program product of breakpoint prediction comprising a computer readable storage device having a computer readable program stored therein. The computer readable program, when executed on a computing device, causes the computing device to access a breakpoint within a set of programming instructions hosted by a compute node in a distributed computing platform. The computer readable program can also cause the computing device to determine data that triggers the breakpoint. The computer readable program can also cause the computing device to access a breakpoint within a set of programming instructions hosted by a compute node in the distributed computing platform. The computer readable program can also cause the computing device to determine data that triggers the breakpoint. The computer readable program can also cause the computing device to create a model for generating a first time-based prediction of when the breakpoint is triggered. The computer readable program can also cause the computing device to monitor for the triggering data. The computer readable program can also cause the computing device to generate, in response to detecting the triggering data, the first time-based prediction and likelihood of the first time-based prediction based on the model. The computer readable program can also cause the computing device to display the first time-based prediction and likelihood of the first time-based prediction.

### BRIEF DESCRIPTION OF THE DRAWINGS

FIG. 1 illustrates a computing infrastructure configured to execute a stream computing application according to various embodiments.

FIG. 2 illustrates a more detailed view of a compute node of FIG. 1 according to various embodiments.

FIG. 3 illustrates a more detailed view of the management system of FIG. 1 according to various embodiments.

FIG. 4 illustrates a more detailed view of the compiler system of FIG. 1 according to various embodiments.

FIG. 5 illustrates an operator graph for a stream computing application according to various embodiments.

FIG. 6 illustrates a method 600 for predicting breakpoints within an application, according to various embodiments.

FIG. 7 illustrates a system 700 of predicting a breakpoint within a streaming application, according to various embodiments.

Like reference numbers and designations in the various drawings indicate like elements.

### DETAILED DESCRIPTION

Aspects of the present disclosure relate to monitoring program execution, and in particular, to monitoring program execution using breakpoints. For instance, aspects of the present disclosure relate to predicting when a breakpoint will occur in an application based upon the presence of one or more triggering data values at an earlier processing stage in the application. A breakpoint can be defined for an application and then a breakpoint analyzer can predict whether one or more data values will trigger the defined breakpoint in the application. The triggering data value can be determined by predicting the data value or predicting the transformation of processing one or more programming instructions into the triggering data value. Once one or more triggering data values are determined, then a breakpoint analysis can be triggered upon the presence of the triggering data value. The breakpoint analysis can involve generating a time-based prediction of when a breakpoint will trigger. The time-based prediction can be a prediction of time until the breakpoint triggers.

While aspects of breakpoint analysis are shown to apply to a distributed computing environment (e.g., a distributed computing platform may be a platform that performs processing on multiple computers such as a stream computing environment), breakpoint analysis may be performed for any application that exists as separate modules run at different times. For instance, an application can be run on one computer system or multiple computer systems with each module being hosted by a separate computer system. The breakpoint may be on a second module while the first module is configured to trigger prediction analysis upon the presence of a triggering data value. The triggering data value can be a data value that is processed by a module, and causes the module to start predicting when a breakpoint will be triggered. The user may utilize the time prediction of when the breakpoint will trigger between the first module and second modules to plan other activities during the debugging. Although not necessarily limited thereto, embodiments of the present disclosure can be appreciated in the context of streaming data and problems relating to routing tuples in the stream of data. Throughout this disclosure, the term stream operator may be abbreviated “S.O.” or “OP”

Stream-based computing and stream-based database computing are emerging as a developing technology for database systems. Products are available which allow users to create applications that process and query streaming data before it reaches a database file. With this emerging technology, users can specify processing logic to apply to inbound data records while they are “in flight,” with the results available in a very short amount of time, often in fractions of a second. Constructing an application using this type of processing has opened up a new programming paradigm that will allow for development of a broad variety of innovative applications, systems, and processes, as well as present new challenges for application programmers and database developers.

In a stream computing application, stream operators are connected to one another such that data flows from one stream operator to the next (e.g., over a TCP/IP socket). When a stream operator receives data, it may perform operations, such as analysis logic, which may change the tuple by adding or subtracting attributes, or updating the values of existing attributes within the tuple. When the analysis logic is complete, a new tuple is then sent to the next stream operator. Scalability is achieved by distributing an application across nodes by creating executables (i.e., processing elements), as well as replicating processing elements on multiple nodes and load balancing among them. Stream operators in a stream computing application can be fused together to form a processing element that is executable. Doing so allows processing elements to share a common process space, resulting in much faster communication between stream operators than is available using inter-process communication techniques (e.g., using a TCP/IP socket). Further, processing elements can be inserted or removed dynamically from an operator graph representing the flow of data through the stream computing application. A particular stream operator may not reside within the same operating system process as other stream operators. In addition, stream operators in the same operator graph may be hosted on different nodes, e.g., on different compute nodes or on different cores of a compute node.

Data flows from one stream operator to another in the form of a “tuple.” A tuple is a sequence of one or more attributes associated with an entity. Attributes may be any of a variety of different types, e.g., integer, float, Boolean, string, etc. The attributes may be ordered. In addition to attributes associated with an entity, a tuple may include metadata, i.e., data about the tuple. A tuple may be extended by adding one or more additional attributes or metadata to it. As used herein, “stream” or “data stream” refers to a sequence of tuples. Generally, a stream may be considered a pseudo-infinite sequence of tuples.

Nonetheless, an output tuple may be changed in some way by a stream operator or processing element. An attribute or metadata may be added, deleted, or modified. For example, a tuple will often have two or more attributes. A stream operator or processing element may receive the tuple having multiple attributes and output a tuple corresponding with the input tuple. The stream operator or processing element may only change one of the attributes so that all of the attributes of the output tuple except one are the same as the attributes of the input tuple.

Generally, a particular tuple output by a stream operator or processing element may not be considered to be the same tuple as a corresponding input tuple even if the input tuple is not changed by the processing element. However, to simplify the present description and the claims, an output tuple that has the same data attributes or is associated with the same entity as a corresponding input tuple will be referred to herein as the same tuple unless the context or an express statement indicates otherwise.

Stream computing applications handle massive volumes of data that need to be processed efficiently and in real time. For example, a stream computing application may continuously ingest and analyze hundreds of thousands of messages per second and up to petabytes of data per day. Accordingly, each stream operator in a stream computing application may be required to process a received tuple within fractions of a second. Unless the stream operators are located in the same processing element, it is necessary to use an inter-process communication path each time a tuple is sent from one stream operator to another. Inter-process communication paths can be a critical resource in a stream computing application. According to various embodiments, the available bandwidth on one or more inter-process communication paths may be conserved. Efficient use of inter-process communication bandwidth can speed up processing.

Streams computing is a distributed programming paradigm where applications are split into pieces such that an application is distributed across a series of processes running on one or more machines. The processes are connected together by sending streams of data into and out of the processes. These streams have attributes and are sent one tuple at a time. Contracts exist between processing elements to establish who sends and receives tuples, i.e., how the processing elements are connected. The processes may run continuously and the processes main thread can be a call back routine that executes when data arrives at any of the incoming ports. The terms stream operator and processing element are both used through this application but may be used interchangeably. For instance, a processing element is an executable for one or more stream operators. Stream operators may transmit a tuple in an operator graph (described further herein). Generally, the operator graph can have a plurality of stream operators that produce a particular end result, e.g., one operator may aggregate an average over a series of tuples.

In order to debug a distributed streams application, a breakpoint may be set in any one of the distributed processes and a user can wait for the breakpoint to be reached. Understanding the duration for a user to wait for that breakpoint to occur can be a daunting task. Since the code executes based off incoming data, a user can wait for an unknown amount of time. For example, if a stream operator upstream in the operator graph is not working and does not send out data, then the lack of data flow to downstream operators may cause a user to wait unnecessarily. In various embodiments, the incoming, queued, and in-flight data being processed can be analyzed and when a breakpoint will be reached, can be estimated.

Aspects of the present disclosure relate to a mechanism to predict when breakpoints will be fired by analyzing the incoming data and its associated patterns of how it traverses an operator graph (i.e., in a stream computing field) in a distributed computing system. Data arriving at an incoming port can be analyzed. This analysis can examine different attributes of the data across one incoming tuple or looking for patterns and running analytics across multiple tuples. Furthermore, multiple tuples across multiple ports can be examined to look for data patterns, abnormalities within the data, data fall out rates, or data transformations that occur. The breakpoint analyzer can use the analysis to make informed decisions on what will happen next with regard to the processing time of a stream operator.

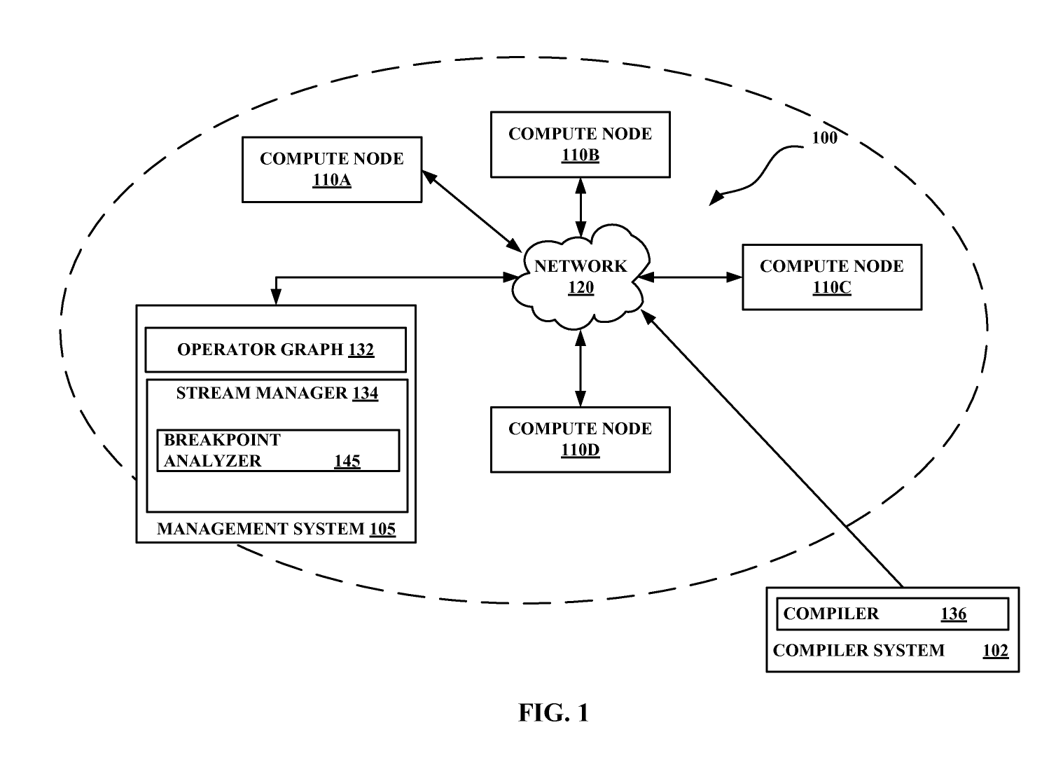

FIG. 1 illustrates one exemplary computing infrastructure 100 that may be configured to execute a stream computing application, according to some embodiments. The computing infrastructure 100 includes a management system 105 and two or more compute nodes 110A-110D—i.e., hosts—which are communicatively coupled to each other using one or more communications networks 120. The communications network 120 may include one or more servers, networks, or databases, and may use a particular communication protocol to transfer data between the compute nodes 110A-110D. A compiler system 102 may be communicatively coupled with the management system 105 and the compute nodes 110 either directly or via the communications network 120.

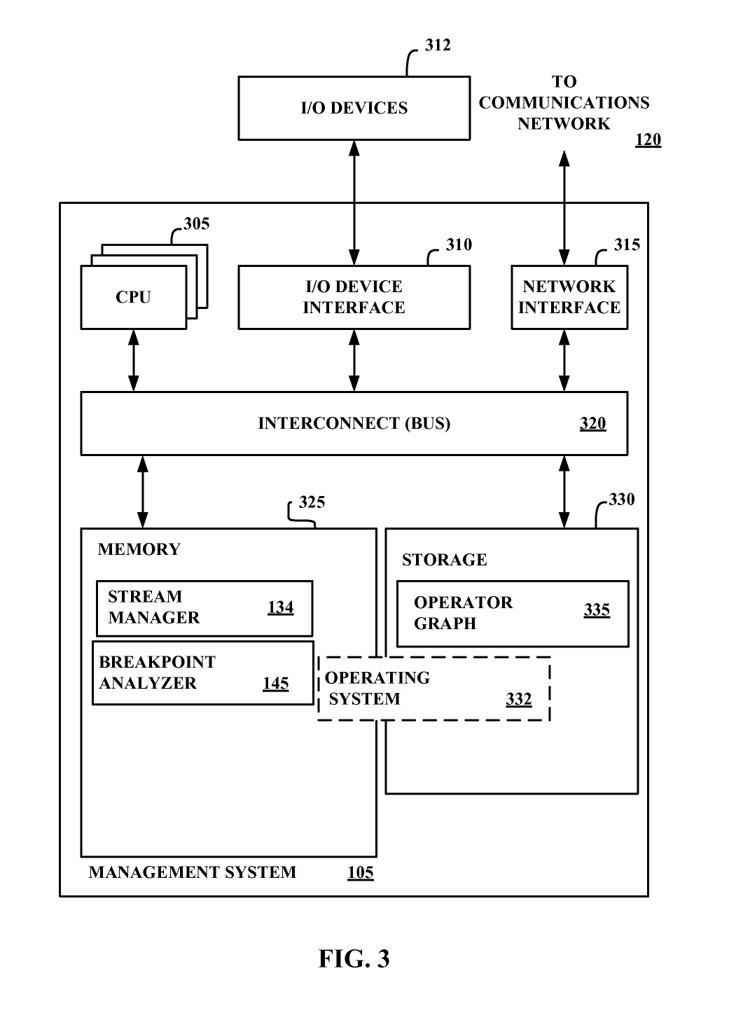

The management system 105 can control the management of the compute nodes 110A-110D (discussed further on FIG. 3). The management system 105 can have an operator graph 132 with one or more stream operators and a stream manager 134 to control the management of the stream of tuples in the operator graph 132. The stream manager 134 can have a breakpoint analyzer 145. The breakpoint analyzer 145 can analyze the triggering data values for a breakpoint and manage the prediction of when a breakpoint is likely to be triggered. Various activities can be performed by a breakpoint analyzer. For instance, the breakpoint analyzer can be used to monitor a computing device and predict when a breakpoint will trigger based on the processing of an application.

The communications network 120 may include a variety of types of physical communication channels or “links.” The links may be wired, wireless, optical, or any other suitable media. In addition, the communications network 120 may include a variety of network hardware and software for performing routing, switching, and other functions, such as routers, switches, or bridges. The communications network 120 may be dedicated for use by a stream computing application or shared with other applications and users. The communications network 120 may be any size. For example, the communications network 120 may include a single local area network or a wide area network spanning a large geographical area, such as the Internet. The links may provide different levels of bandwidth or capacity to transfer data at a particular rate. The bandwidth that a particular link provides may vary depending on a variety of factors, including the type of communication media and whether particular network hardware or software is functioning correctly or at full capacity. In addition, the bandwidth that a particular link provides to a stream computing application may vary if the link is shared with other applications and users. The available bandwidth may vary depending on the load placed on the link by the other applications and users. The bandwidth that a particular link provides may also vary depending on a temporal factor, such as time of day, day of week, day of month, or season.

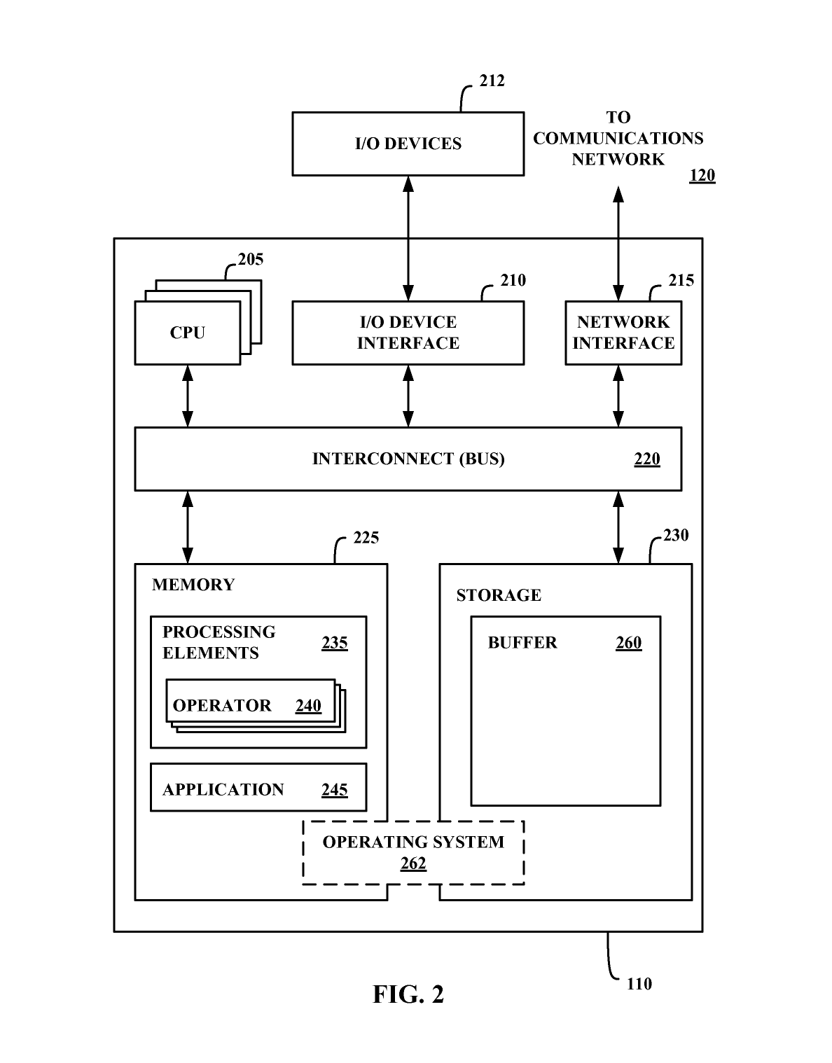

FIG. 2 is a more detailed view of a compute node 110, which may be the same as one of the compute nodes 110A-110D of FIG. 1, according to various embodiments. The compute node 110 may include, without limitation, one or more processors (CPUs) 205, a network interface 215, an interconnect 220, a memory 225, and a storage 230. The compute node 110 may also include an I/O device interface 210 used to connect I/O devices 212, e.g., keyboard, display, and mouse devices, to the compute node 110.

Each CPU 205 retrieves and executes programming instructions stored in the memory 225 or storage 230. Similarly, the CPU 205 stores and retrieves application data residing in the memory 225. The interconnect 220 is used to transmit programming instructions and application data between each CPU 205, I/O device interface 210, storage 230, network interface 215, and memory 225. The interconnect 220 may be one or more busses. The CPUs 205 may be a single CPU, multiple CPUs, or a single CPU having multiple processing cores in various embodiments. In one embodiment, a processor 205 may be a digital signal processor (DSP). One or more processing elements 235 (described below) may be stored in the memory 225. A processing element 235 may include one or more stream operators 240 (described below). In one embodiment, a processing element 235 is assigned to be executed by only one CPU 205, although in other embodiments the stream operators 240 of a processing element 235 may include one or more threads that are executed on two or more CPUs 205. The memory 225 is generally included to be representative of a random access memory, e.g., Static Random Access Memory (SRAM), Dynamic Random Access Memory (DRAM), or Flash. The storage 230 is generally included to be representative of a non-volatile memory, such as a hard disk drive, solid state device (SSD), or removable memory cards, optical storage, flash memory devices, network attached storage (NAS), or connections to storage area network (SAN) devices, or other devices that may store non-volatile data. The network interface 215 is configured to transmit data via the communications network 120.

A stream computing application may include one or more stream operators 240 that may be compiled into a “processing element” container 235. The memory 225 may include two or more processing elements 235, each processing element having one or more stream operators 240. Each stream operator 240 may include a portion of code that processes tuples flowing into a processing element and outputs tuples to other stream operators 240 in the same processing element, in other processing elements, or in both the same and other processing elements in a stream computing application. Processing elements 235 may pass tuples to other processing elements that are on the same compute node 110 or on other compute nodes that are accessible via communications network 120. For example, a processing element 235 on compute node 110A may output tuples to a processing element 235 on compute node 110B.

Various applications 245 may be present within the compute node. The application 245 is a set of programming instructions that is executed on the computer node 110 to perform a task. For example, application 245 can include the stream computing application or a performance application. Breakpoints are not necessarily defined to a stream computing application. Aspects of the invention are performed by one or more computer processors (i.e., CPUs 205) and memory 225 within a computing device. For instance, programming instructions that make the application 245 are stored in memory (e.g., 225) and processed using one or more computer processors (i.e., CPUs 205). Breakpoints are identified as programming instructions and are processed by the one or more computer processors (i.e., CPUs 205). The breakpoints are predicted based on real-time processing on the computer processor (i.e., CPUs 205).

The storage 230 may include a buffer 260. Although shown as being in storage, the buffer 260 may be located in the memory 225 of the compute node 110 or in a combination of both memories. Moreover, storage 230 may include storage space that is external to the compute node 110, such as in a cloud.

The compute node 110 may include one or more operating systems 262. An operating system 262 may be stored partially in memory 225 and partially in storage 230. Alternatively, an operating system may be stored entirely in memory 225 or entirely in storage 230. The operating system provides an interface between various hardware resources, including the CPU 205, and processing elements and other components of the stream computing application. In addition, an operating system provides common services for application programs, such as providing a time function.

FIG. 3 is a more detailed view of the management system 105 of FIG. 1 according to some embodiments. The management system 105 may include, without limitation, one or more processors (CPUs) 305, a network interface 315, an interconnect 320, a memory 325, and a storage 330. The management system 105 may also include an I/O device interface 310 connecting I/O devices 312, e.g., keyboard, display, and mouse devices, to the management system 105.

Each CPU 305 retrieves and executes programming instructions stored in the memory 325 or storage 330. Similarly, each CPU 305 stores and retrieves application data residing in the memory 325 or storage 330. The interconnect 320 is used to move data, such as programming instructions and application data, between the CPU 305, I/O device interface 310, storage unit 330, network interface 315, and memory 325. The interconnect 320 may be one or more busses. The CPUs 305 may be a single CPU, multiple CPUs, or a single CPU having multiple processing cores in various embodiments. In one embodiment, a processor 305 may be a DSP. Memory 325 is generally included to be representative of a random access memory, e.g., SRAM, DRAM, or Flash. The storage 330 is generally included to be representative of a non-volatile memory, such as a hard disk drive, solid state device (SSD), removable memory cards, optical storage, Flash memory devices, network attached storage (NAS), connections to storage area-network (SAN) devices, or the cloud. The network interface 315 is configured to transmit data via the communications network 120.

The memory 325 may store a stream manager 134. The stream manager 134 can have software features that enable the stream manager 134 to manage the stream operators on the operator graph 335. The memory 325 may also support a breakpoint analyzer 145. In various embodiments, the breakpoint analyzer 145 may be separate from the stream manager 134. For example, if the compute node 110 is not a part of a streams processing environment, then the breakpoint analyzer 145 may be independent from the streams processing environment. Additionally, the storage 330 may store an operator graph 335. The operator graph 335 may define how tuples are routed to processing elements 235 (FIG. 2) for processing.

The management system 105 may include one or more operating systems 332. An operating system 332 may be stored partially in memory 325 and partially in storage 330. Alternatively, an operating system may be stored entirely in memory 325 or entirely in storage 330. The operating system provides an interface between various hardware resources, including the CPU 305, and processing elements and other components of the stream computing application. In addition, an operating system provides common services for application programs, such as providing a time function.

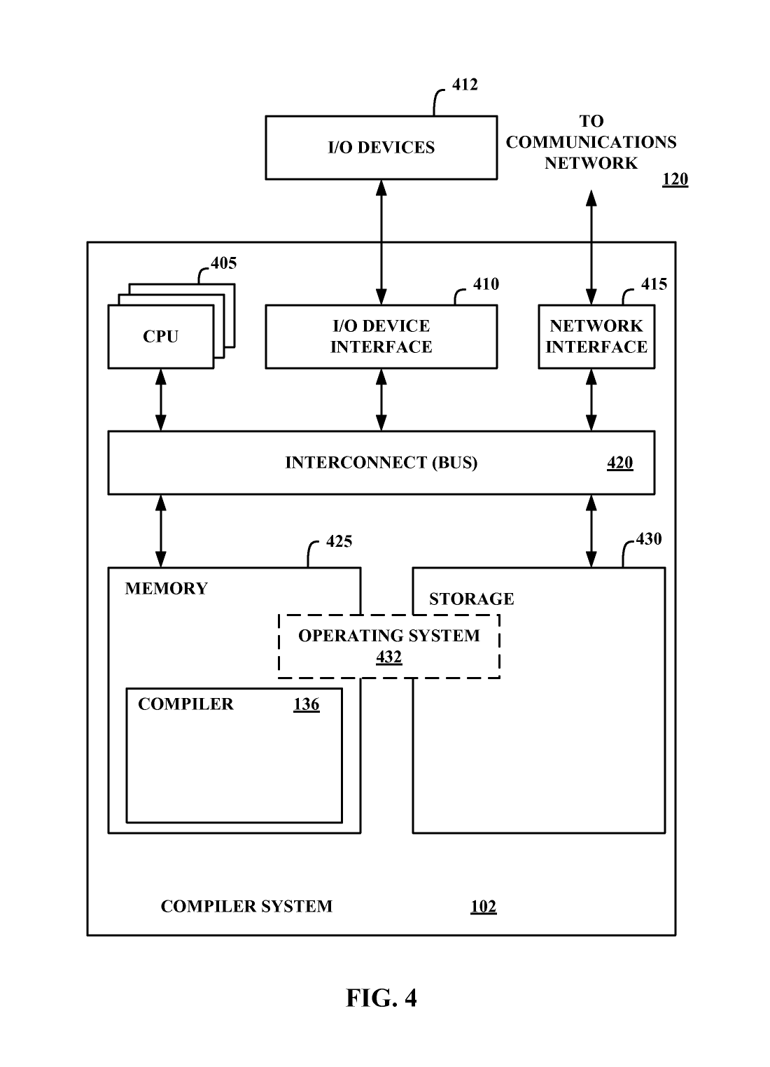

FIG. 4 is a more detailed view of the compiler system 102 of FIG. 1 according to some embodiments. The compiler system 102 may include, without limitation, one or more processors (CPUs) 405, a network interface 415, an interconnect 420, a memory 425, and storage 430. The compiler system 102 may also include an I/O device interface 410 connecting I/O devices 412, e.g., keyboard, display, and mouse devices, to the compiler system 102.

Each CPU 405 retrieves and executes programming instructions stored in the memory 425 or storage 430. Similarly, each CPU 405 stores and retrieves application data residing in the memory 425 or storage 430. The interconnect 420 is used to move data, such as programming instructions and application data, between the CPU 405, I/O device interface 410, storage unit 430, network interface 415, and memory 425. The interconnect 420 may be one or more busses. The CPUs 405 may be a single CPU, multiple CPUs, or a single CPU having multiple processing cores in various embodiments. In one embodiment, a processor 405 may be a DSP. Memory 425 is generally included to be representative of a random access memory, e.g., SRAM, DRAM, or Flash. The storage 430 is generally included to be representative of a non-volatile memory, such as a hard disk drive, solid state device (SSD), removable memory cards, optical storage, flash memory devices, network attached storage (NAS), connections to storage area-network (SAN) devices, or to the cloud. The network interface 415 is configured to transmit data via the communications network 120.

The compiler system 102 may include one or more operating systems 432. An operating system 432 may be stored partially in memory 425 and partially in storage 430. Alternatively, an operating system may be stored entirely in memory 425 or entirely in storage 430. The operating system provides an interface between various hardware resources, including the CPU 405, and processing elements and other components of the stream computing application. In addition, an operating system provides common services for application programs, such as providing a time function.

The memory 425 may store a compiler 136. The compiler 136 compiles modules, which include source code or statements, into the object code, which includes machine instructions that execute on a processor. In one embodiment, the compiler 136 may translate the modules into an intermediate form before translating the intermediate form into object code. The compiler 136 may output a set of deployable artifacts that may include a set of processing elements and an application description language file (ADL file), which is a configuration file that describes the stream computing application. In some embodiments, the compiler 136 may be a just-in-time compiler that executes as part of an interpreter. In other embodiments, the compiler 136 may be an optimizing compiler. In various embodiments, the compiler 136 may perform peephole optimizations, local optimizations, loop optimizations, inter-procedural or whole-program optimizations, machine code optimizations, or any other optimizations that reduce the amount of time required to execute the object code, to reduce the amount of memory required to execute the object code, or both. The output of the compiler 136 may be represented by an operator graph, e.g., the operator graph 335.

In various embodiments, the compiler 136 can include the windowing operation on a particular stream operator on the operator graph 335 during compile time by writing the windowing operation onto a particular stream operator. In various embodiments, the windowing operation may be included as a default and activated from the stream manager 134. The windowing operation may also be included as an optional feature for a particular stream operator and may be activated by the application.

The compiler 136 may also provide the application administrator with the ability to optimize performance through profile-driven fusion optimization. Fusing operators may improve performance by reducing the number of calls to a transport. While fusing stream operators may provide faster communication between operators than is available using inter-process communication techniques, any decision to fuse operators requires balancing the benefits of distributing processing across multiple compute nodes with the benefit of faster inter-operator communications. The compiler 136 may automate the fusion process to determine how to best fuse the operators to be hosted by one or more processing elements, while respecting user-specified constraints. This may be a two-step process, including compiling the application in a profiling mode and running the application, then re-compiling and using the optimizer during this subsequent compilation. The end result may, however, be a compiler-supplied deployable application with an optimized application configuration.

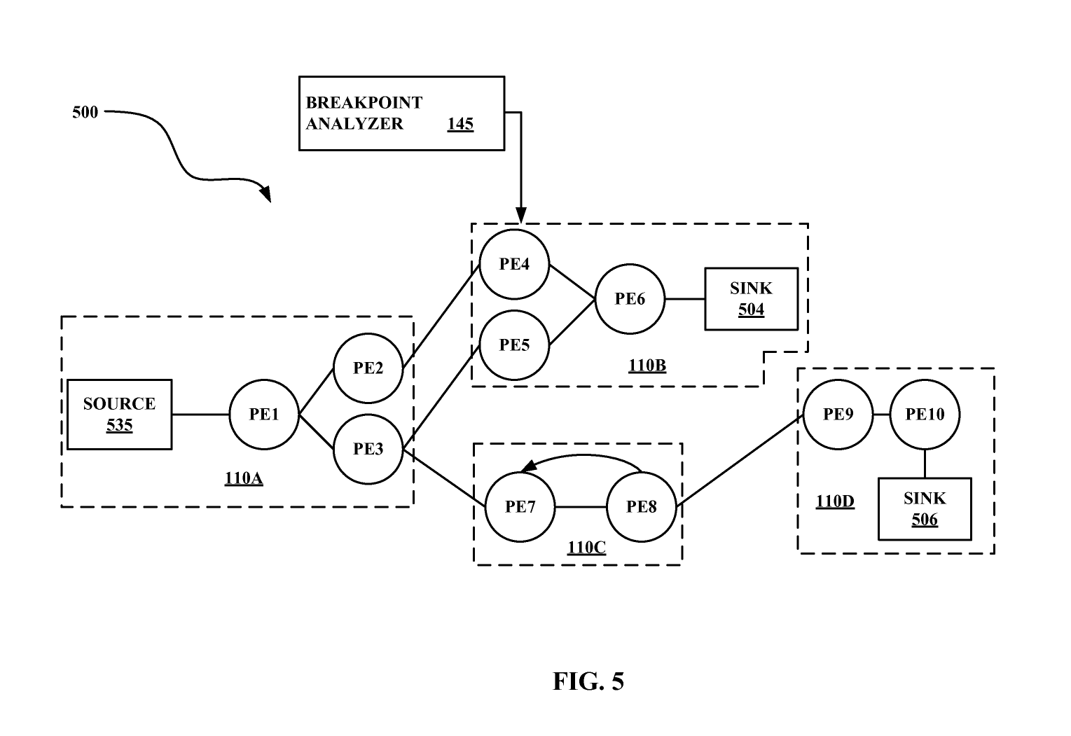

FIG. 5 illustrates an exemplary operator graph 500 for a stream computing application beginning from one or more sources 535 through to one or more sinks 504, 506, according to some embodiments. This flow from source to sink may also be generally referred to herein as an execution path. In addition, a flow from one processing element to another may be referred to as an execution path in various contexts. Although FIG. 5 is abstracted to show connected processing elements PE1-PE10, the operator graph 500 may include data flows between stream operators 240 (FIG. 2) within the same or different processing elements. Typically, processing elements, such as processing element 235 (FIG. 2), receive tuples from the stream as well as output tuples into the stream (except for a sink—where the stream terminates, or a source—where the stream begins). While the operator graph 500 includes a relatively small number of components, an operator graph may be much more complex and may include many individual operator graphs that may be statically or dynamically linked together.

The example operator graph shown in FIG. 5 includes ten processing elements (labeled as PE1-PE10) running on the compute nodes 110A-110D. A processing element may include one or more stream operators fused together to form an independently running process with its own process ID (PID) and memory space. In cases where two (or more) processing elements are running independently, inter-process communication may occur using a “transport,” e.g., a network socket, a TCP/IP socket, or shared memory. Inter-process communication paths used for inter-process communications can be a critical resource in a stream computing application. However, when stream operators are fused together, the fused stream operators can use more rapid communication techniques for passing tuples among stream operators in each processing element.

The operator graph 500 begins at a source 535 and ends at a sink 504, 506. Compute node 110A includes the processing elements PE1, PE2, and PE3. Source 535 flows into the processing element PE1, which in turn outputs tuples that are received by PE2 and PE3. For example, PE1 may split data attributes received in a tuple and pass some data attributes in a new tuple to PE2, while passing other data attributes in another new tuple to PE3. As a second example, PE1 may pass some received tuples to PE2 while passing other tuples to PE3. Tuples that flow to PE2 are processed by the stream operators contained in PE2, and the resulting tuples are then output to PE4 on compute node 110B. Likewise, the tuples output by PE4 flow to operator sink PE6 504. Similarly, tuples flowing from PE3 to PE5 also reach the operators in sink PE6 504. Thus, in addition to being a sink for this example operator graph, PE6 could be configured to perform a join operation, combining tuples received from PE4 and PE5. This example operator graph also shows tuples flowing from PE3 to PE7 on compute node 110C, which itself shows tuples flowing to PE8 and looping back to PE7. Tuples output from PE8 flow to PE9 and PE10 on compute node 110D, which in turn outputs tuples to be processed by operators in a sink processing element 506.

Processing elements 235 (FIG. 2) may be configured to receive or output tuples in various formats, e.g., the processing elements or stream operators could exchange data marked up as XML documents. Furthermore, each stream operator 240 within a processing element 235 may be configured to carry out any form of data processing functions on received tuples, including, for example, writing to database tables or performing other database operations such as data joins, splits, reads, etc., as well as performing other data analytic functions or operations.

The stream manager 134 of FIG. 1 may be configured to monitor a stream computing application running on compute nodes, e.g., compute nodes 110A-110D, as well as to change the deployment of an operator graph, e.g., operator graph 132. The stream manager 134 may move processing elements from one compute node 110 to another, for example, to manage the processing loads of the compute nodes 110A-110D in the computing infrastructure 100. Further, stream manager 134 may control the stream computing application by inserting, removing, fusing, un-fusing, or otherwise modifying the processing elements and stream operators (or what tuples flow to the processing elements) running on the compute nodes 110A-110D.

The operator graph 500 may additionally include a breakpoint analyzer 145. The breakpoint analyzer 145 may receive various performance criteria relating to the processing time of the compute nodes 110A-110D. The breakpoint analyzer 145 may incorporate the performance criteria into a predictive model (which is also referred to as a model). The breakpoint analyzer 145 may work in conjunction with the stream manager to identify the data containing the breakpoint in an upstream processing operation (e.g., PE1). For example, if the data (e.g., a tuple) that will trigger the breakpoint in PE6 is detected in PE1 (or in an upstream processing operation from PE6), then breakpoint analyzer 145 can predict when the data will trigger PE6 based on the performance of the compute nodes 110A-110B.

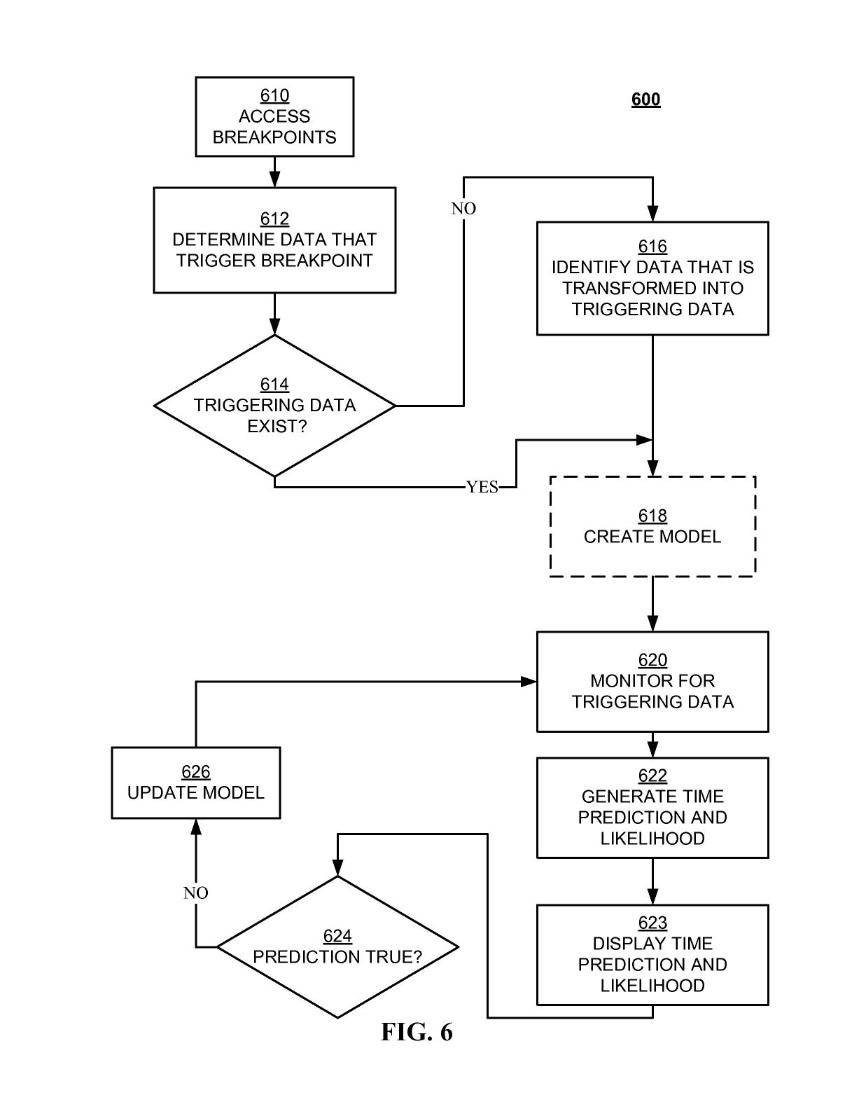

FIG. 6 illustrates a method 600 for predicting breakpoints within an application, according to various embodiments. The method 600 can apply for a breakpoint analyzer which may be part of a stream manager in a stream computing environment or an independent monitoring agent within a distributed computing system (e.g., cloud computing). The method 600 involves analyzing the incoming data, coming up with a predictive model with simple rules to determine when a breakpoint will be hit. In the streams environment case, a tuple with the “matching” values is found and then the breakpoint analyzer estimates when the tuple will reach a given operator and trigger a breakpoint. For example, matching values may be used to imply whether or not a tuple meets the criteria to cause a breakpoint and can be a function of the values of some or all of the attributes of the tuple.

The application can be hosted on multiple compute nodes and each module of the application can have different breakpoints. For example, each module of an application can be hosted on different compute nodes and the time when a breakpoint is triggered on one server may be predicted based on the flow of data within the application. Each module of the application can be called at a different time than another module within the application. In a simplified example, if module A on server 1 transmits data to module B on server 2, and the module B contains a breakpoint that is triggered by a particular data value, then the presence of the data value on server 1 can indicate that that the breakpoint in module B can eventually be triggered.

In operation 610, the breakpoint analyzer can access breakpoints within the application. The breakpoints can be mapped by the breakpoint analyzer based on various breakpoints that are identified. In various embodiments, the breakpoints can be received by the breakpoint analyzer and transmitted by the runtime.

In various embodiments, a specialized analysis engine from the runtime can analyze programming instructions for the application to detect a breakpoint. The analysis engine can search the programming instructions for lines of code that typically indicate a breakpoint. For example, a loop followed by “break” within the loop may indicate a breakpoint. The analysis engine can transmit the breakpoint to the breakpoint analyzer so that the breakpoint is mapped within a repository.

In various embodiments, a user can define a breakpoint within a set of programming instructions on an application hosted by a compute node in a distributed computing platform. Breakpoints may be set by a user that debugs code. When the user sets a breakpoint, an instruction is added to the code to indicate to stop, i.e., break. If the breakpoint is defined by a user, then the breakpoint analyzer would receive a defined breakpoint. The breakpoint analyzer would identify all of the defined breakpoints within the application.

In operation 612, the breakpoint analyzer can determine data that triggers the breakpoint within the application. For instance, the breakpoint can be triggered by a particular data value for a variable. In a streaming application, the data can be in the form of attributes within tuples analyzed by the operator graph. The breakpoint analyzer can analyze the programming instructions to determine the particular data value that triggers the breakpoint. In various embodiments, a simulation can be performed by the breakpoint analyzer to determine how the programming instructions handle data values for variables. For example, the simulation can use a test set provided by the user to use for variable values in order to determine application behavior. The values from the test set that trigger a breakpoint can be used as triggering data values. In various embodiments, a user can provide the triggering data to the breakpoint analyzer based on an analysis of the application. Thus, the breakpoint analyzer can receive the triggering data values.

In operation 614, the breakpoint analyzer determines whether the triggering data exists. For example, the breakpoint analyzer can determine whether a first data value is present. In determining data values that can trigger a breakpoint, the breakpoint analyzer may also determine whether any data that triggers a breakpoint can exist. For example, the breakpoint analyzer may determine that data values that trigger the breakpoint do not exist based on the analysis of the programming instructions. Additional data values may trigger the breakpoint but may be dependent on other application modules. If there are no triggering data values present, then the method 600 can continue to operation 616. For instance, if there are no triggering data values present, then the breakpoint analyzer can evaluate and identify transformations on the data that would cause breakpoints.

In operation 616, the breakpoint analyzer can identify, in response to the first data value not being present, a second data value that transforms into the first data value. In a stream computing example, tuples entering the operator graph might have known transformations that cause a data value to be changed to the triggering data value. The breakpoint analyzer can use a predictive model to determine whether the first data value will be present. For example, if the first data value that triggers the breakpoint in the application is not present, then the predictive model can be used to determine if any other module of the application transforms a second data value into the first data value. The predictive model is a prediction engine that predicts how a module can perform. In various embodiments, the predictive model is a simulation that is compiled beforehand. The predictive model may also operate in a parallel process to the runtime.

In operation 618, the breakpoint analyzer can create a model for generating a time-based prediction of when the breakpoint is triggered. The model is predictive and based on the processing performance of the underlying computing system. For example, the performance (e.g., processing times) of the various modules of the application are incorporated in the model. Although shown as occurring after operation 616, the model may be created at any point in the method 600. For example, the model can relate to the application that is supported by the computing system. Any changes to the application or the underlying computing system can result in changes to the model. For example, if there is a reduction in CPUs allocated to the application, then the model changes because the model predicts how fast the data in the application is processed.

The model can predict the likelihood of when the breakpoint triggering within the application occurs. For example, the presence of transformed data that is transformed into triggering data may have a lower likelihood of triggering the breakpoint, than the presence of triggering data. Dropped tuples or complex dependencies can also reduce the likelihood of a breakpoint being triggered. For example, if triggered data has to be processed by seven modules until it triggers the breakpoint at the eighth module, then the likelihood of the breakpoint triggering is less than if the triggered data has to be processed by two modules since not all tuples are sent to every operator.

As an illustrative example, previous iterations of data that are processed with 3 computer systems have an 80% probability of triggering the breakpoint within 10 minutes. Previous iterations of data processed with 1 computer systems have a 90% probability of triggering the breakpoint within 10 minutes. Thus, the model can predict that the triggering data being processed by 4 computers would have less than an 80% probability of triggering the breakpoint within 10 minutes. The model can examine the performance of different computer systems to determine bottlenecks and offer predictions based on the performance.

In another illustrative example involving a streams-based computing system, the model may consider the percentage of time a tuple with matching values reaches the destination point (i.e., the drop-out rate of tuples before reaching the operator in question). For example, various tuples may not transform into a certain value. A portion of tuples entering an operator graph may not make it to all operators because the portion of tuples are filtered out of the application or do not reach specific stream operators. The aforementioned examples are for a predictive model and rule set for the model that can be used to facilitate the prediction. In actual implementation, the rule set could either be simplistic or become quite complex.

Additional embodiments can include a user interface associated with a debugger that would be updated with two features. A first feature of the user interface may be a display that includes the estimated time before the breakpoint is going to be hit. A second feature of the user interface may be a display of the likelihood of the breakpoint being reached. Various thresholds could also be used where the breakpoint only occurs after N matching tuples are processed on the stream operator. In the case of thresholds, an estimated time and the likelihood of the breakpoint being reached can also include the current number of matches.

In operation 620, the breakpoint analyzer can monitor for the triggering data. Once defined, the triggering data can be monitored. For example, processing of triggering data at a first module of an application, can trigger the prediction of when the breakpoint in a second module is triggered. Various dependencies can exist between different modules. For example, the breakpoint in a second module can be determined based on a second triggering data on a first module. The triggering data can be detected based on the module alerting the breakpoint analyzer about the presence of the triggering data (e.g., through a call-back routine to the runtime).

In operation 622, the breakpoint analyzer can generate, in response to detecting the triggering data, the time-based prediction and likelihood of the time-based prediction based on the model. For example, the model can produce a time-based prediction for when the breakpoint is likely to trigger within the application. Since there may be multiple dependencies that affect the processing of data, then the breakpoint analyzer can also include a likelihood or probability of the prediction being true. For example, for a breakpoint involving one module of an application, the breakpoint analyzer can predict that the processing time within various computer systems is 10 minutes. The application can be run on 4 computer systems before the breakpoint is triggered.

The breakpoint analyzer can predict that the probability of attaining a breakpoint in 10 minutes is 50%. The breakpoint analyzer can determine the likelihood of attaining the breakpoint by using historical breakpoint results. The display can include a time estimate for the breakpoint to trigger. In a stream computing example, as a tuple flows thru an operator graph, the time a tuple takes to progress thru the graph and reach the operator that has the breakpoint set can be estimated. Besides simply estimating the time to hit the breakpoint, a breakpoint analyzer can also be configured to alert the user when the breakpoint will not be triggered. For example, if a stream operator upstream in the operator graph stops producing data, or fails to function, then the breakpoint analyzer can alert the user. For example, the breakpoint analyzer can alert the user, in response to the likelihood of the time-based prediction being unlikely. Unlikely, in this case, can be when the likelihood is substantially zero percent.

In operation 623, the breakpoint analyzer can cause the runtime to create a user display to display the time prediction and the likelihood. For instance, the user display can be displayed on a compute node or a management system. In various embodiments, the breakpoint analyzer can update the user display with prediction times at defined intervals, e.g., a count-down. For instance, the model may be used to predict an initial time-prediction (a first time-prediction) for triggering a breakpoint, and count-down from the initial time-prediction in real-time.

In various embodiments, the breakpoint analyzer can generate multiple time-based predictions at intervals of time. For example, if the time-based prediction is 10 minutes, then the breakpoint analyzer can generate a new time-based prediction every minute for 10 minutes. The tenth time-based prediction can be evaluated against the actual processing time for a tenth processing time measurement in ten intervals. The breakpoint analyzer can receive a defined period of time from a user. The breakpoint analyzer can generate a second time-based prediction based on the first time-based prediction and the defined period of time. For example, if the first time-based prediction is 10 minutes, and the defined period of time is 2 minutes, then every two minutes, a new prediction can be performed based on the analysis of the modules. In another example, the first time-based prediction is 10 minutes, and the defined period of time is 2 minutes, then every 2 minutes, the user display can subtract 2 minutes from the first time-based prediction until the prediction becomes zero. The breakpoint analyzer can display the second time-based prediction as well as the likelihood of the second-time based prediction. In various embodiments, the time-based prediction can become more likely as the total time approaches the first time-based prediction.

In operation 624, the breakpoint analyzer can determine whether the time-based prediction is accurate. To determine whether the time-based prediction is accurate, the breakpoint analyzer can monitor when the actual breakpoint is triggered by the triggering data. The time-based prediction of the breakpoint is accurate when the prediction is within a certain threshold range of the actual breakpoint. The threshold range may be dependent on a percentage of the actual and the predicted, a defined time value, or likelihood of the breakpoint triggering. The threshold may be dependent on the likelihood of the breakpoint triggering. For example, if the actual breakpoint is triggered at 15 minutes from when the triggering data is first detected at operation 620, but the model predicted a 98% probability of triggering at 10 minutes, then the prediction is not accurate. However, if the model predicted a 10% probability of triggering at 10 minutes, then the prediction was accurate. The time difference between the prediction of the breakpoint and the actual breakpoint may be accurate depending on the threshold range. A user may define the threshold range in order to determine whether the model needs to be updated.

In operation 626, the breakpoint analyzer can update the model, in response to the time-based prediction being accurate, by replacing the one or more performance metrics for a computer system (i.e., a compute node) with a newer performance metric. The newer performance metric can be based on the time received by the breakpoint analyzer. For example, the breakpoint analyzer can receive actual performance metrics from the computer system that is hosting a module of the application. The processing of the data in the module can cause the model to generate a predicted performance metric and an actual performance metric. If the predicted performance metric and the actual performance metric are not within the same threshold range (as determined herein), then the breakpoint analyzer can update the predicted performance metric with the actual performance metric.

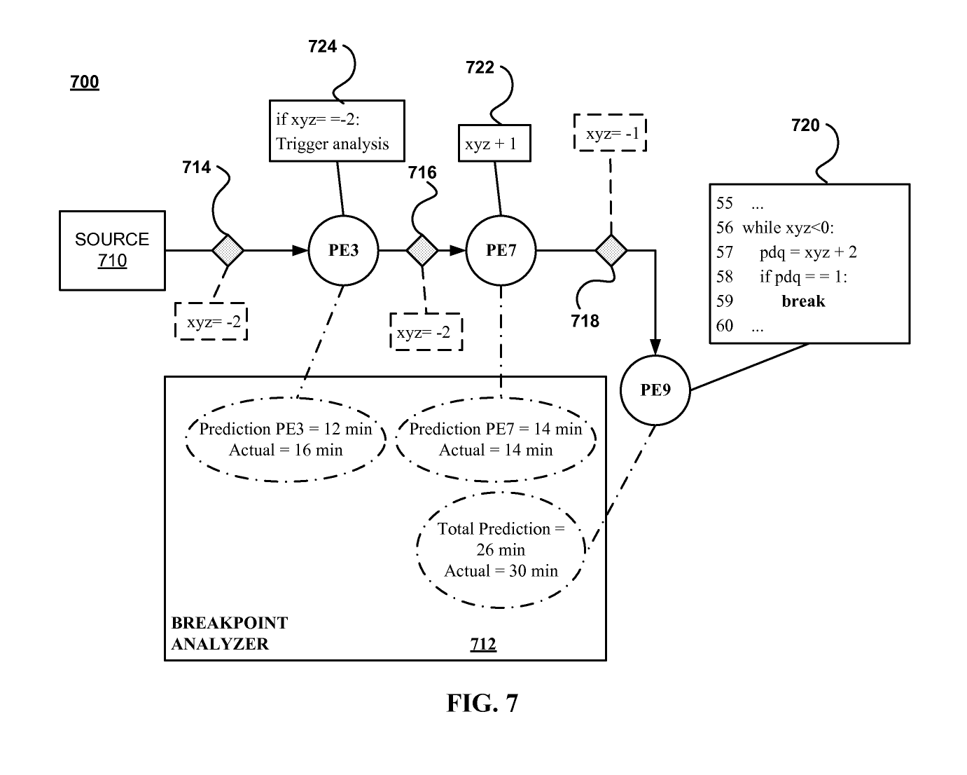

FIG. 7 illustrates a system 700 of predicting a breakpoint within a streaming application, according to various embodiments. The system 700 can be an operator graph that is similar to the operator graph 500 in FIG. 5. For instance, the processing element PE3 is hosted by a first compute node, the processing element PE7 is hosted by a second compute node, and the processing element PE9 is hosted by a third compute node.

In various embodiments, a breakpoint analyzer 712 can receive a defined breakpoint in PE9. For example, in the pseudo code 720 for the processing element, a breakpoint is written into lines 58 and 59. The breakpoint triggers if “pdq” equals one. The breakpoint analyzer 712 can analyze the processing elements PE7 and PE3 to determine if any processing operations affect the value for “pdq” directly. In this instance, PE7 has a processing operation that affects “xyz” which in turn affects the value for “pdq”. For example, PE7 has pseudo code 722 that provides that one is added to the value of xyz. Since the value of xyz of −2 can trigger the breakpoint at PE9, then the breakpoint analyzer 712 can monitor for the “xyz” value of −2 at a processing element upstream from PE7 (i.e., PE3). For example, the breakpoint analyzer 712 can incorporate the following condition into PE3 exemplified by pseudo code 724. Thus, when the xyz value of −2 is triggered, then the breakpoint analyzer 712 begins a prediction analysis of when the breakpoint is likely to be triggered.

The system 700 may have a processing element PE3 that receives a first tuple 714 from a source 710. The first tuple 714 may be a tuple from a stream of tuples to be processed. The first tuple 714 can have an “xyz” value of −2 as an initial value. Since “xyz” has a value of −2, then the analysis can be triggered at PE3. After being processed by PE3, the first tuple 716 has an “xyz” value of −2. At PE7, the “xyz” value has one added and creates the first tuple 718. The first tuple 718 has an “xyz” value of −1. The first tuple 718 is received by PE9. In PE9, the “xyz” value of −1 causes the “pdq” value to be 1 which triggers the breakpoint.

The breakpoint prediction analysis can be triggered by the receipt of the first tuple 714 at PE3. Once triggered, the breakpoint analyzer 712 can analyze the compute nodes to predict processing times. The breakpoint analyzer 712 can use a model that relies on historical processing times of similar tuples. For example, certain tuples can share similarities in processing throughout an operator graph. Like tuples may trigger the same processing elements or stream operators. In the system 700, the breakpoint analyzer 712 can use the predicted processing time to determine an overall predicted processing time until the breakpoint is triggered. For example, the predicted processing time of first tuple 714 at PE3 is 12 minutes, the predicted processing time of first tuple 716 at PE7 is 14 minutes, and the total predicted processing time is 26 minutes. Thus, from when the detection of the first tuple 714 triggers the breakpoint analysis, until the breakpoint is triggered, is predicted to be 26 minutes.

Once the first tuple is processed by a processing element, the breakpoint analyzer 712 can record the actual processing time in order to update the processing model. For example, even though the predicted processing time for the first tuple 714 was 12 minutes, the actual processing time may be 16 minutes. The model may be updated by the breakpoint analyzer 712. For example, by incorporating the actual processing time for a processing element (e.g., PE3) into the model, an updated average or median processing time for the processing element can create a more accurate model for future predictions.

The actual processing time can be used to validate the model. For example, in PE7 the predicted processing time is 14 minutes while the actual processing time is also 14 minutes. In various embodiments, the model may be validated whenever the actual time is within a particular threshold from the predicted time. The threshold may be based on a whole value (e.g., plus or minus 2 minutes) or based on a relative value (e.g., a percentage of the predicted). The total prediction from PE3 and PE7 can be the sum of the individual predictions from the processing elements between the trigger and the breakpoint. In various embodiments, the breakpoint analyzer 712 can use the total actual time to validate the model against the total predicted time.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of exemplary embodiments of the various embodiments, reference was made to the accompanying drawings (where like numbers represent like elements), which form a part hereof, and in which is shown by way of illustration specific exemplary embodiments in which the various embodiments may be practiced. These embodiments were described in sufficient detail to enable those skilled in the art to practice the embodiments, but other embodiments may be used and logical, mechanical, electrical, and other changes may be made without departing from the scope of the various embodiments. In the previous description, numerous specific details were set forth to provide a thorough understanding the various embodiments. But, the various embodiments may be practiced without these specific details. In other instances, well-known circuits, structures, and techniques have not been shown in detail in order not to obscure embodiments.

Different instances of the word “embodiment” as used within this specification do not necessarily refer to the same embodiment, but they may. Any data and data structures illustrated or described herein are examples only, and in other embodiments, different amounts of data, types of data, fields, numbers and types of fields, field names, numbers and types of rows, records, entries, or organizations of data may be used. In addition, any data may be combined with logic, so that a separate data structure may not be necessary. The previous detailed description is, therefore, not to be taken in a limiting sense.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present invention has been described in terms of specific embodiments, it is anticipated that alterations and modification thereof will become apparent to the skilled in the art. Therefore, it is intended that the following claims be interpreted as covering all such alterations and modifications as fall within the true spirit and scope of the invention.

In the foregoing, reference is made to various embodiments. It should be understood, however, that this disclosure is not limited to the specifically described embodiments. Instead, any combination of the described features and elements, whether related to different embodiments or not, is contemplated to implement and practice this disclosure. Furthermore, although embodiments of this disclosure may achieve advantages over other possible solutions or over the prior art, whether or not a particular advantage is achieved by a given embodiment is not limiting of this disclosure. Thus, the described aspects, features, embodiments, and advantages are merely illustrative and are not considered elements or limitations of the appended claims except where explicitly recited in a claim(s).

Although embodiments are described within the context of a stream computing application, this is not the only context relevant to the present disclosure. Instead, such a description is without limitation and is for illustrative purposes only. Additional embodiments may be configured to operate with any computer system or application capable of performing the functions described herein. For example, embodiments may be configured to operate in a clustered environment with a standard database processing application. A multi-nodal environment may operate in a manner that effectively processes a stream of tuples. For example, some embodiments may include a large database system, and a query of the database system may return results in a manner similar to a stream of data.

While the foregoing is directed to exemplary embodiments, other and further embodiments of the disclosure may be devised without departing from the basic scope thereof, and the scope thereof is determined by the claims that follow.

1-7. (canceled)

8. A system of breakpoint prediction, comprising:
one or more compute nodes operating in a distributed computing platform;
a memory;
a computer processor communicatively coupled to the memory;
a breakpoint analyzer communicatively coupled to the memory and the computer processor, wherein the breakpoint analyzer is configured to:
access a breakpoint within a set of programming instructions hosted by a compute node in the distributed computing platform;
determine data that triggers the breakpoint;
create a model for generating a first time-based prediction of when the breakpoint is triggered;
monitor for triggering data;
generate, in response to detecting the triggering data, the first time-based prediction and likelihood of the first time-based prediction based on the model; and
display the first time-based prediction and likelihood of the first time-based prediction.

9. The system of claim 8, wherein the breakpoint analyzer is configured to determine the data by:
determining whether a first data value is present.

10. The system of claim 9, wherein the breakpoint analyzer is configured to determine the data by:
identifying, in response to the first data value not being present, a second data value that transforms into the first data value using the model.

11. The system of claim 8, wherein the breakpoint analyzer is configured to create the model by:
adding one or more performance metrics of one or more compute nodes within the distributed computing platform.

12. The system of claim 11, wherein the breakpoint analyzer is configured to create the model by:
determining whether the first time-based prediction is accurate;
updating the model, in response to the first time-based prediction being accurate, by replacing the one or more performance metrics for a compute node with a newer performance metric.

13. The system of claim 8, wherein the breakpoint analyzer is configured to display the first time-based prediction and likelihood of the first time-based prediction by:
alerting a user, in response to the likelihood of the first time-based prediction being unlikely.

14. The system of claim 8, wherein the breakpoint analyzer is configured to:
receive a defined period of time;
generate a second time-based prediction based on the first time-based prediction and the defined period of time; and
display the second time-based prediction.

15. A computer program product for breakpoint prediction comprising a computer readable storage device having a computer readable program stored therein, wherein the computer readable program, when executed on a computing device, causes the computing device to:
access a breakpoint within a set of programming instructions hosted by a compute node in a distributed computing platform;
determine data that triggers the breakpoint;
create a model for generating a first time-based prediction of when the breakpoint is triggered;
monitor for triggering data;
generate, in response to detecting the triggering data, the first time-based prediction and likelihood of the first time-based prediction based on the model; and
display the first time-based prediction and likelihood of the first time-based prediction.

16. The computer program product of claim 15, wherein the computer readable program causes the computing device to determine the data by:
determining whether a first data value is present.

17. The computer program product of claim 16, wherein the computer readable program causes the computing device to determine the data by:
identifying, in response to the first data value not being present, a second data value that transforms into the first data value using the model.

18. The computer program product of claim 15, wherein the computer readable program causes the computing device to create the model by:
adding one or more performance metrics of one or more compute nodes within the distributed computing platform.

19. The computer program product of claim 18, wherein the computer readable program causes the computing device to create the model by:
determining whether the first time-based prediction is accurate;
updating the model, in response to the first time-based prediction being accurate, by replacing the one or more performance metrics for a compute node with a newer performance metric.

20. The computer program product of claim 15, wherein the computer readable program causes the computing device to:
receive a defined period of time;
generate a second time-based prediction based on the first time-based prediction and the defined period of time; and
display the second time-based prediction.
